(19) United States
(12) Patent Application Publication
(10) Pub. No.: US 2025/0229720 A1
(43) Pub. Date: Jul. 17, 2025

(54) MULTI-STAGE OPEN-TYPE VEHICULAR STORAGE COMPARTMENT

(71) Applicants: Hyundai Motor Company, Seoul (KR); Kia Corporation, Seoul (KR); Duck Yang Industry Co., Ltd., Ulsan (KR)

(72) Inventors: Wan-Dong Jo, Hwaseong-si (KR); Dong-Han Kim, Hwaseong-si (KR); Do-Won Kim, Hwaseong-si (KR); Cheol-Hee Yeon, Anyang-si (KR)

(21) Appl. No.: 18/945,801

(22) Filed: Nov. 13, 2024

(30) Foreign Application Priority Data
Jan. 16, 2024 (KR) 10-2024-0006709

(51) Int. Cl. B60R 7/04

(52) U.S. Cl. CPC B60R 7/046

(57) ABSTRACT

An embodiment multi-stage open-type storage compartment for a vehicle includes a housing disposed inside the vehicle, an accommodation space defined within the housing, wherein the accommodation space is configured to accommodate an article, an inner cover rotatably disposed in the housing, the inner cover being configured to open and close a front surface of the housing, a guide slot disposed in the housing, the guide slot including a plurality of sections arranged as portions, respectively, of circles having different radii and centered around a rotational center of the inner cover, the plurality of sections being connected to each other, and a control lever rotatably disposed on a lateral surface of the inner cover, wherein the guide slot is configured to guide a movement of the control lever.

### CROSS-REFERENCE TO RELATED APPLICATIONS

This application claims the benefit of Korean Patent Application No. 10-2024-0006709, filed on Jan. 16, 2024, which application is hereby incorporated herein by reference in its entirety.

### TECHNICAL FIELD

The present disclosure relates to a vehicular storage compartment inside a vehicle.

### BACKGROUND

Various storage compartments for accommodating various articles are installed inside a vehicle.

For example, as illustrated in FIG. 1, a storage compartment is installed in a door 100 of the vehicle in an openable and closable manner, and various articles can be accommodated within the storage compartment.

The compartment storage includes a housing 120 and a cover 130 in a door trim 110 installed in the door 100. The housing 120 accommodates an article, and the cover 130 opens and closes a front surface of the housing 120. The cover 130 is installed in a manner that is only openable by a predetermined angle α with respect to the housing 120. As illustrated in FIG. 2, the cover 130 is hinge-connected to the housing 120. Rotation of the cover 130 opens and closes the housing 120. The cover 130 is installed in such a manner as to excessively open the housing 120. A slot 121 is formed in the housing 120. A stopper 160 is installed on one side of the cover 130 in such a manner that stopper 160 moves inside the slot 121 and restricts an opening angle α of the cover 130.

This structure prevents the cover 130 from being excessively opened. The advantage thereof is that the excessive opening of the cover 130 that inconveniences an occupant does not take place. That is, the excessive opening of the cover 130 causes interference with the body of the occupant, thereby causing the occupant the inconvenience. When the cover 130 is opened, the restriction of the opening angle α of the cover 130 can prevent the cover 130 from interfering with the body of the occupant.

However, since the opening angle α of the cover 130 is restricted, a large-volume article cannot be accommodated. In order for the housing 120 to accommodate a large-volume article, the cover 130 has to be sufficiently opened. However, the restriction of the opening angle α prevents the large-volume article from being accommodated into the housing 120.

In addition, in order to clean the inside of the storage compartment, the cover 130 has to be sufficiently opened in such a manner as to facilitate insertion of a cleaning tool or the like into the storage compartment. Since the cover 130 is not sufficiently opened, it is not easy to clean the inside of the storage compartment. Since the inside of the storage compartment is not properly cleaned, a problem arises in that foreign material is accumulated without being discharged.

### SUMMARY

The present disclosure relates to a vehicular storage compartment inside a vehicle, within which an article is accommodated. Particular embodiments relate to a multi-stage open-type vehicular storage compartment capable of being opened to multi-stages to facilitate cleaning thereof and article accommodation.

An embodiment of the present disclosure, which may solve problems in the art, provides a multi-stage open-type vehicular storage compartment capable of selecting an opening angle of a cover thereof and thus maximally opening the cover whenever necessary.

In order to accomplish the above-mentioned object, according to one embodiment of the present disclosure, there is provided a multi-stage open-type vehicular storage compartment including a housing installed inside a vehicle, an accommodation unit, within which an article is accommodated, being formed in the housing, an inner cover rotatably installed in the housing and opening and closing a front surface of the housing, and a control lever rotatably installed on a lateral surface of the inner cover, wherein a guide slot, which guides movement of the control lever, is formed in the housing, wherein the guide slot is made up of a plurality of sections that are formed as portions, respectively, of circles having different radii and are centered around the rotational center of the inner cover, and wherein the plurality of sections are connected to each other.

In the multi-stage open-type vehicular storage compartment, when the inner cover rotates by a predetermined angle, the control lever may reach an end portion of one of the plurality of sections, thereby restricting the inner cover, and, when the control lever rotates at a position where the rotation of the inner cover is restricted, the control lever may move to an adjacent another section, thereby allowing the rotation of the inner cover.

In the multi-stage open-type vehicular storage compartment, the plurality of sections may be formed in such a manner that the greater an opening angle of the inner cover, the farther the plurality of sections are positioned away from the rotational center of the inner cover.

In the multi-stage open-type vehicular storage compartment, a stopper may be protrusively formed on an end portion of the control lever in such a manner as to move along the inside of the guide slot, to restrict a rotational angle of the inner cover, and to pass through the guide slot.

In the multi-stage open-type vehicular storage compartment, when the stopper reaches one of the plurality of sections, the stopper may restrict the rotation of the inner cover, and, when the stopper moves from an ending point of the section to an adjacent another section, the stopper may allow the rotation of the inner cover.

In the multi-stage open-type vehicular storage compartment, an operation portion to which an operation force rotating the control lever is applied may be protrusively disposed on the other end portion of the control lever.

In the multi-stage open-type vehicular storage compartment, the control lever may be elastically supported toward the rotational center of the inner cover.

In the multi-stage open-type vehicular storage compartment, the control lever may be rotatably installed on a rotational shaft formed on the inner cover, and a torsion spring may be installed on the rotational shaft in which one end portion of the torsion spring is fixed to the inner cover, the other end portion of the torsion spring is fixed to a spring fixation portion formed on the control lever, and the torsion spring elastically supports the stopper toward the rotational center of the inner cover.

In the multi-stage open-type vehicular storage compartment, a lever cover which covers the control lever may be formed on an outer surface of the inner cover.

In the multi-stage open-type vehicular storage compartment, an operation groove through which the operation portion passes may be formed in the lever cover, a guide groove through which the stopper passes may be formed in the lever cover, and the operation groove and the guide groove may restrict a rotational angle of the control lever.

In the multi-stage open-type vehicular storage compartment, a cover plate may be coupled to a front surface of the inner cover, a rod may be installed, in a manner that is slidable in the widthwise direction of the inner cover, between the inner cover and the cover plate, and it may be installed in a manner that is insertable into a locking groove formed in the housing, and a button that is operated in such a manner as to separate the inner cover from the housing may be included in the housing.

In the multi-stage open-type vehicular storage compartment, the button may include a pushing portion that is pushed by an occupant in the vehicle and an operation portion coming into inclined contact with the pushing portion and thus separating the rod from the housing.

The multi-stage open-type vehicular storage compartment may further include a guide guiding sliding of a pair of the rods and a pinion engaged with rack gear portions formed on the pair of the rods, respectively.

In the multi-stage open-type vehicular storage compartment, the housing may be fixed to a door trim provided on a door of the vehicle.

The multi-stage open-type vehicular storage compartment according to embodiments of the present disclosure, which has the configuration as described above, includes the inner cover that can be opened to multi-stages, thereby accommodating a large-volume article and facilitating cleaning of the inside of the storage compartment.

In addition, during normal usage, the cover is opened to the first stage. Thus, a phenomenon can be prevented where a front surface of the inner cover interferes with the body of the occupant.

### BRIEF DESCRIPTION OF THE DRAWINGS

FIG. 1 is a perspective view illustrating a state where a vehicular storage compartment in the related art is installed in a door of a vehicle.

FIG. 2 is a side view illustrating the vehicular storage compartment in the related art.

FIG. 3 is a perspective view illustrating a state where a multi-stage open-type vehicular storage compartment according to embodiments of the present disclosure is installed in the door of the vehicle.

FIG. 4 is an exploded perspective view illustrating the multi-stage open-type vehicular storage compartment according to embodiments of the present disclosure and a door trim.

FIG. 5 is a perspective view illustrating the multi-stage open-type vehicular storage compartment according to the present disclosure.

FIG. 6 is an exploded perspective view illustrating the multi-stage open-type vehicular storage compartment according to embodiments of the present disclosure.

FIG. 7 is a perspective view illustrating a control lever of the multi-stage open-type vehicular storage compartment according to embodiments of the present disclosure.

FIG. 8 is a side view illustrating an operational relationship between a guide slot in a housing of the multi-stage open-type vehicular storage compartment according to embodiments of the present disclosure and the control lever thereof.

FIG. 9 is a side view illustrating a closed state of the multi-stage open-type vehicular storage compartment according to embodiments of the present disclosure.

FIG. 10 is a perspective view illustrating a state where the multi-stage open-type vehicular storage compartment according to embodiments of the present disclosure is opened to the first stage.

FIG. 11 is a side view illustrating the state where the multi-stage open-type vehicular storage compartment according to embodiments of the present disclosure is opened to the first stage.

FIG. 12 is a schematic view illustrating a positional relationship between the guide slot and the control lever that results when the multi-stage open-type vehicular storage compartment according to embodiments of the present disclosure is opened to the first stage.

FIG. 13 is a perspective view illustrating a state where the control lever is in operation when the multi-stage open-type vehicular storage compartment according to embodiments of the present disclosure is fully opened to the first stage.

FIG. 14 is a side view illustrating the state where the control lever is in operation when the multi-stage open-type vehicular storage compartment according to embodiments of the present disclosure is fully opened to the first stage.

FIG. 15 is a schematic view illustrating a positional relationship between the guide slot and the control lever that results when the multi-stage open-type vehicular storage compartment according to embodiments of the present disclosure is fully opened to the first stage.

FIG. 16 is a perspective view illustrating a state where the control lever is in operation when the multi-stage open-type vehicular storage compartment according to embodiments of the present disclosure is opened to the second stage.

FIG. 17 is a side view illustrating a state where the multi-stage open-type vehicular storage compartment according to embodiments of the present disclosure is opened to the second stage.

FIG. 18 is a schematic view illustrating a positional relationship between the guide slot and the control lever that results when the multi-stage open-type vehicular storage compartment according to embodiments of the present disclosure is opened to the second stage.

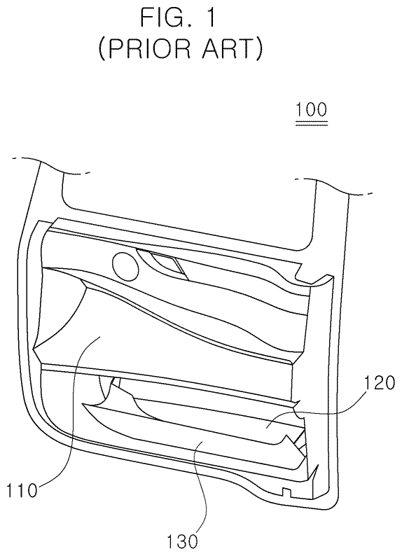

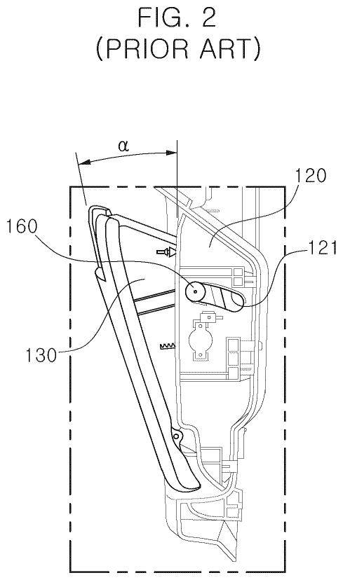

### DETAILED DESCRIPTION OF ILLUSTRATIVE EMBODIMENTS

A multi-stage open-type vehicular storage compartment according to embodiments of the present disclosure will be described in detail below with reference to the accompanying drawings.

The multi-stage open-type vehicular storage compartment according to embodiments of the present disclosure includes a housing 20, an inner cover 30, and a control lever 60. Accommodation units 21 and 22, within each of which an article may be accommodated, are formed in the housing 20, and the housing 20 is installed inside a vehicle. The inner cover 30 is rotatably installed in the housing 20 and opens and closes a front surface of the housing 20. The control lever 60 is rotatably installed on a lateral surface of the inner cover 30. In the multi-stage open-type vehicular storage compartment, a guide slot 24, which guides movement of the control lever 60, is formed in the housing 20. Furthermore, the guide slot 24 is made up of a plurality of sections 24a and 24b, that are formed as portions, respectively, of circles having different radii and are centered around the rotational center of the inner cover 30. Furthermore, the sections 24a and 24b are connected to each other.

The housing 20 is installed inside the vehicle, and an article may be accommodated within the housing 20. For example, the housing 20 may be installed in a door 1 of the vehicle. One or all peripheral portions of the housing 20 are fixedly installed in the door trim 10 provided on the door 1. Thus, an occupant of the vehicle can accommodate an article inside the door 1.

At least one of the accommodation units 21 and 22 capable of accommodating an article is formed inside the housing 20. The front surface of the housing 20 and an upper surface thereof are open to load and unload the article, and both lateral surfaces and a bottom surface thereof are closed, thereby forming the accommodation units 21 and 22. A space inside the housing 20 is partitioned, thereby forming a plurality of the accommodation units, like as a first accommodation unit 21 and a second accommodation unit 22.

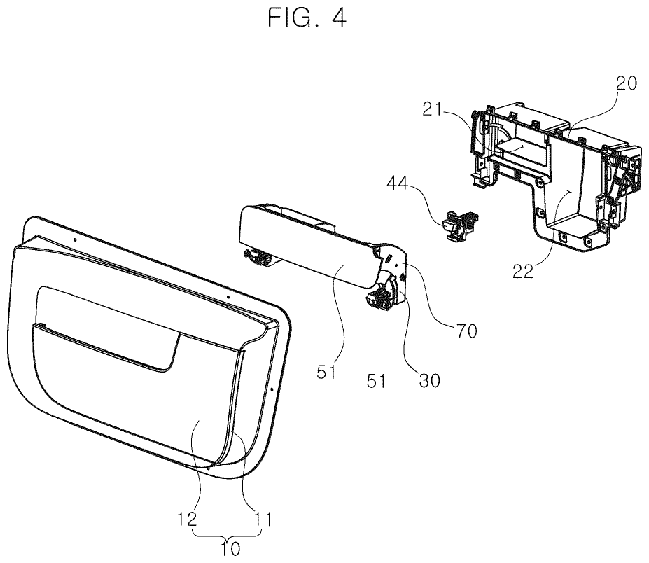

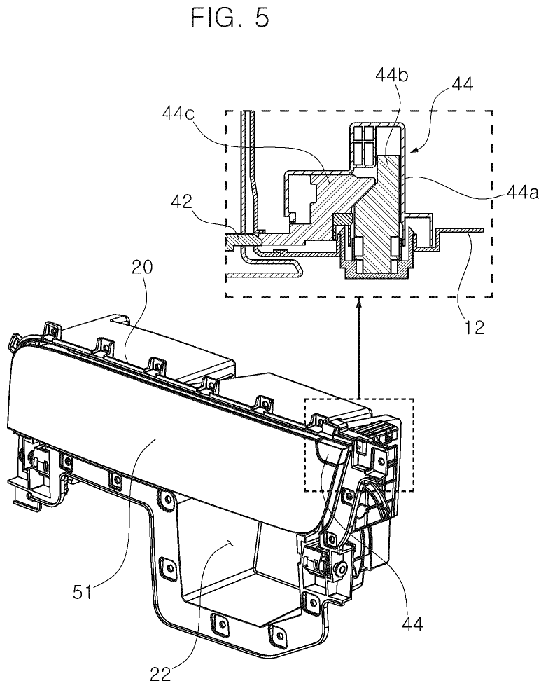

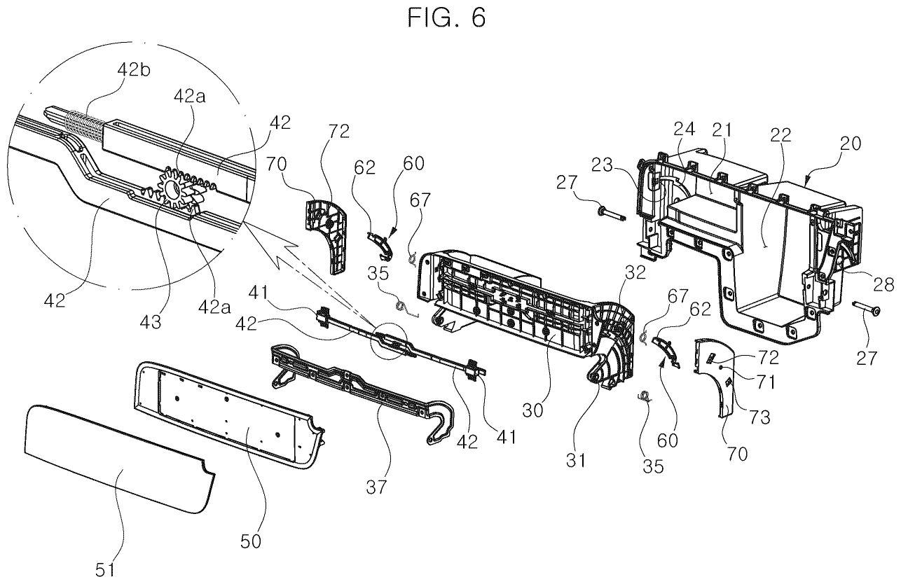

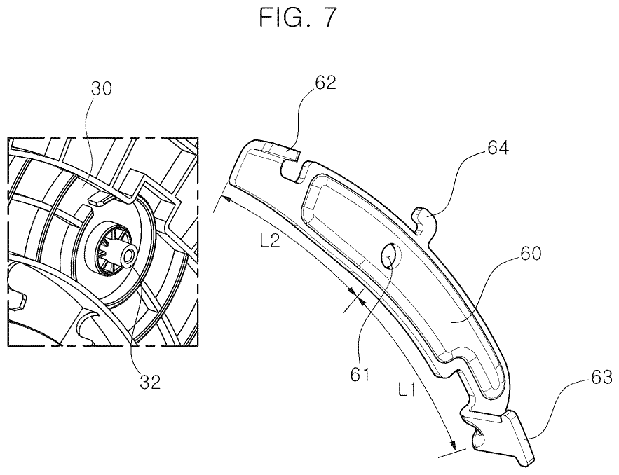

In FIGS. 4 and 6, the accommodation units 21 and 22 are made up of the first accommodation unit 21 and the second accommodation unit 22. The second accommodation unit 22 is formed to a greater depth than the first accommodation unit 21, allowing accommodation of an article with a greater height.

The guide slot 24 guiding the movement of the control lever 60 described below is formed in the lateral surface of the housing 20.

The inner cover 30 opens and closes the front surface of the housing 20 that faces toward the inside of the vehicle. The inner cover 30 is rotatably installed on the housing 20. Thus, the rotation of the inner cover 30 closes the front surface of the housing 20 or opens the front surface of the housing 20 in such a manner that an article is loaded and unloaded into and out of the accommodation unit 21 or 22.

The inner cover 30 is formed in a bent way in such a manner that both lateral surfaces thereof overlap inner surfaces, respectively, of the housing 20, so that the inner cover 30 is accommodated within the housing 20. The inner cover 30 is formed in such a manner that lower end portions of both lateral surfaces of the inner cover 30 are respectively hinge-connected to the housing 20, thereby opening and closing the housing 20. A through-hole 31 is formed in a lower end portion of the inner cover 30. A hinge pin 27 is installed in such a manner as to pass through the through-hole 31 and the housing 20. Thus, the inner cover 30 is rotatably installed in the housing 20.

In addition, a torsion spring 35 is installed on the hinge pin 27. Both end portions of the torsion spring 35 are fixed to the housing 20 and the inner cover 30, respectively. The torsion spring 35 elastically supports the inner cover 30 in the direction of opening.

The inner cover 30 is engaged with an oil damper 28 installed on the housing 20. Thus, when opening the inner cover 30, an opening speed of the inner cover 30 is controlled in such a manner as to slowly open the inner cover 30.

A reinforcement bracket 37 for reinforcing the rigidity of the inner cover 30 is fastened to a lower portion of the inner cover 30. The reinforcement bracket 37 is formed to a shape that surrounds the lower portion of the inner cover 30. Since the reinforcement bracket 37 is fastened to the lower portion of the inner cover 30, the rigidity of the inner cover 30 reinforces.

A cover plate 50 is fastened to a front surface of the inner cover 30. A locking unit is positioned between the cover plate 50 and the inner cover 30 and is installed on the housing 20. The locking unit keeps the inner cover 30 closed.

The locking unit includes a pair of rods 42, guides 41, a pinion 43, and a button 44. The pair of rods 42 is installed between the inner cover 30 and the cover plate 50 in a manner that is slidable in the widthwise direction of the inner cover 30. The guides 41 guide sliding of the rods 42, respectively. The pinion 43 simultaneously operates the pair of rods 42. The button 44 is operated by the occupant.

The guides 41 are installed on the front surface of the inner cover 30, and the rods 42 are installed inside the guides 41.

The rods 42 are provided in one pair and are installed between the inner cover 30 and the cover plate 50 in a manner that is slidable in the widthwise direction of the inner cover 30. The rods 42 are restricted by the guides 41 and thus slide in the widthwise direction of the inner cover 30. When one end portion of the rod 42 is inserted into a locking groove 23 formed in the housing 20, the inner cover 30 can be kept closed. When the one end portion of the rod 42 is separated from the locking groove 23, the inner cover 30 can be opened. One end portion of one rod 42 and one end portion of the other rod 42 protrude toward both lateral end portions, respectively, of the inner cover 30. Thus, both lateral end portions of the inner cover 30 are fixed to the housing 20.

The other end portion of the rod 42 is elastically supported by a return spring 42b. The one end portion of the rod 42 protrudes from the inner cover 30 and is inserted into the locking groove 23.

The pinion 43 simultaneously operates the rods 42 in a pair. That is, rack gear portions 42a are formed on the rods 42, respectively, and are engaged with the pinion 43. Thus, when one of the rods 42 in a pair slides, the other rod 42 also slides. The rods 42 in a pair simultaneously slide toward the inside or outside of the inner cover 30.

The button 44 is installed on one side of the housing 20. The inner cover 30 closes the housing 20 and where the end portion of the rod 42 is inserted into the locking groove 23, thereby locking the inner cover 30. The button 44 enables this state where the inner cover 30 is locked to be changed to a state where the inner cover 30 is openable. The button 44 includes a casing 44a, a pushing portion 44b, and an operation portion 44c. The casing 44a is fixed to the housing 20. The pushing portion 44b is installed on the casing 44a and is pushed by the occupant. The operation portion 44c comes into inclined contact with the pushing portion 44b and slides the end portion of the rod 42 toward the inside of the inner cover 30.

Respective inclined surfaces of the pushing portion 44b and the operation portion 44c come into contact with each other. Because of this, when the pushing portion 44b is pushed, the operation portion 44c operates in a direction perpendicular to a direction of the operation of the pushing portion 44b, that is, in the widthwise direction of the inner cover 30. Thus, the end portion of the rod 42 is pushed toward the inside of the inner cover 30, and one end portion of the rod 42 is separated from the locking groove 23. Accordingly, the inner cover 30 can be rotated with respect to the housing 20.

A skin 51, a finishing material, is attached on a front surface of the cover plate 50. When the inner cover 30 closes the housing 20, the skin 51 forms the exterior appearance of the vehicular storage compartment according to embodiments of the present disclosure.

The control lever 60 is rotatably installed on the lateral surface of the inner cover 30. In addition, one side of the control lever 60 is inserted into the guide slot 24, and the inner cover 30 is opened to multi-stages by the guide slot 24. That is, the control lever 60, along with the inner cover 30, rotates, but the operation of the control lever 60 is guided by the guide slot 24. Thus, the inner cover 30 is opened to multi-stages. When the inner cover 30 rotates by a predetermined angle, the control lever 60 reaches an end portion of one of the plurality of sections, like the first section 24a and the second section 24b, and thus restricts rotation of the inner cover 30. When the control lever 60 rotates in a position at which the rotation of the inner cover 30 is restricted, the control lever 60 moves to the other one of the sections 24a and 24b, thereby allowing the rotation of the inner cover 30.

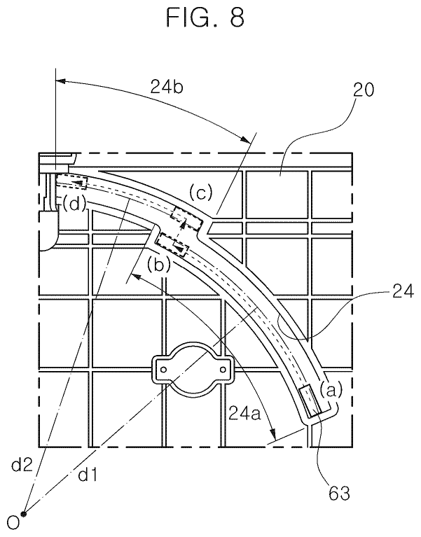

The guide slot 24 formed in the lateral surface of the housing 20 is made up of the plurality of sections, for example the first section 24a and the second section 24b, that are formed as portions, respectively, of circles having different radii and are centered around the rotational center of the inner cover 30. Furthermore, the plurality of sections 24a and 24b are formed in such a manner as to be connected to each other. FIG. 8 illustrates an example where the first section 24a is formed, as one portion of a circle with radius d1, in the guide slot 24, the circle being centered around the rotational center of the inner cover 30, and where the second section 24b is formed, as one portion of a circle with radius d2, in the guide slot 24, the circle being centered around the rotational center of the inner cover 30. The guide slot 24 is formed in such a manner as to have the first section 24a and the second section 24b. Thus, the inner cover 30 can be opened to two stages. The first section 24a is formed in such a manner as to connect to the second section 24b at the end portion. If the guide slot 24 has three sections, the inner cover 30 may be opened to three stages.

The plurality of sections 24a and 24b are formed in such a manner that the greater an opening angle of the inner cover 30, the farther the plurality of sections are positioned away from the rotational center of the inner cover 30. That is, the second section 24b is formed in such a manner as to be positioned farther away from the rotational center of the inner cover 30 than the first section 24a.

A through-hole 61 is formed in the middle of the control lever 60. A rotational shaft 32 formed on the inner cover 30 passes through the through-hole 61. The control lever 60 is rotatably installed on the inner cover 30.

In addition, a stopper 63, which moves along the guide slot 24, is formed on one end portion of the control lever 60, and an operation portion 62 is formed on the other end portion thereof. The operation portion 62 operates the control lever 60 in such a manner that, when the inner cover 30 rotates by a predetermined angle, the stopper 63 moves from the present section to the next section.

The stopper 63 is formed in a manner that protrudes from one end portion of the control lever 60 and passes through the guide slot 24. The stopper 63 restricts the opening angle of the inner cover 30 while moving along the inside of the guide slot 24. For example, when the stopper 63 reaches an end portion of the first section 24a, the inner cover 30 no longer rotates. In a state where the stopper 63 is movable within the second section 24b after moving to the second section 24b, the inner cover 30 is also openable in two stages. FIG. 8 illustrates a positional relationship between the guide slot 24 and the stopper 63. In FIG. 8, in the guide slot 24, the stopper 63 moves from position (a) to position (d) through positions (b) and (c). The stopper 63 is positioned at a position (a) in a state where the inner cover 30 is closed. When the inner cover 30 is opened to the first stage, the stopper 63 moves from position (a) toward position (b) along the first section 24a. When the inner cover 30 is fully opened to the first stage, the stopper 63 is positioned at position (b). Subsequently, the control lever 60 rotates, and thus the stopper 63 moves to position (c), thereby being in a state where the stopper 63 is movable within the second section 24b. Subsequently, when the inner cover 30 is opened to the second stage, the stopper 63 moves from position (c) toward position (d). When the inner cover 30 is fully opened to the second stage, the stopper 63 is positioned at position (d). Conversely, when the inner cover 30 is closed, the stopper 63 moves in the opposite direction at the guide slot 24.

The operation portion 62 protrudes from the other end portion of the control lever 60. When the stopper 63 reaches one of the sections 24a and 24b, the occupant applies an operation force to the operation portion 62 in such a manner that the control lever 60 is rotatable. Accordingly, the stopper 63 moves to the adjacent section 24a or 24b.

A torsion spring 67 is installed on the rotational shaft 32 in such a manner that the control lever 60 causes the stopper 63 to face toward the rotational center of the inner cover 30. One end portion of the torsion spring 67 is fixed to the inner cover 30, and the other end portion thereof is fixed to a spring fixation portion 64 formed on the control lever 60. Thus, the torsion spring 67 elastically supports in such a manner that the stopper 63 faces toward the rotational center of the inner cover 30.

In addition, the control lever 60 is formed in such a manner that a distance from the rotational center of the control lever 60 to the stopper 63 is greater than a distance from the rotational center of the control lever 60 to the operation portion 62. Accordingly, even using its weight, the control lever 60 causes the stopper 63 to face toward the rotational center of the inner cover 30.

The lever cover 70 is fixed to an outer surface of the housing 20 in such a manner as to cover the control lever 60. The circumference of the lever cover 70 is inserted into the inner cover 30, and the lever cover 70 is coupled to the inner cover 30. Thus, the control lever 60 is covered in such a manner as not to be exposed to the outside. However, the stopper 63 and the operation portion 62 on the control lever 60 have to be exposed to the outside. To this end, an operation groove 72 through which the operation portion 62 passes is formed in the lever cover 70, and a guide groove 73 through which the stopper 63 passes is formed in the lever cover 70. In addition, a through-hole 71 through which the rotational shaft 32 passes may be formed in the lever cover 70. The operation groove 72 and the guide groove 73 serve to restrict a rotational angle of the control lever 60 in the inner cover 30.

The operation of the multi-stage open-type vehicular storage compartment according to embodiments of the present disclosure that employs the above-described configuration is described as follows.

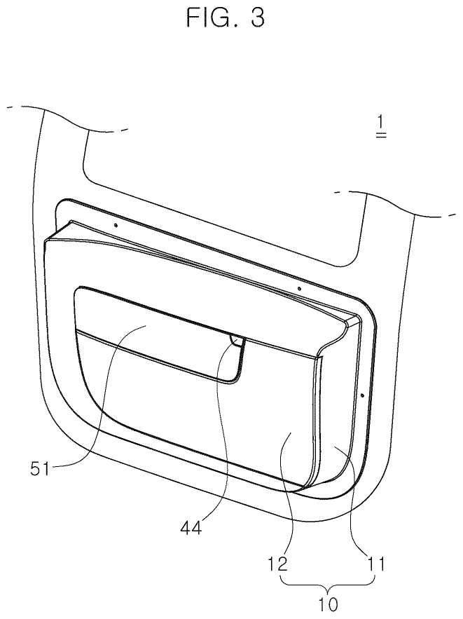

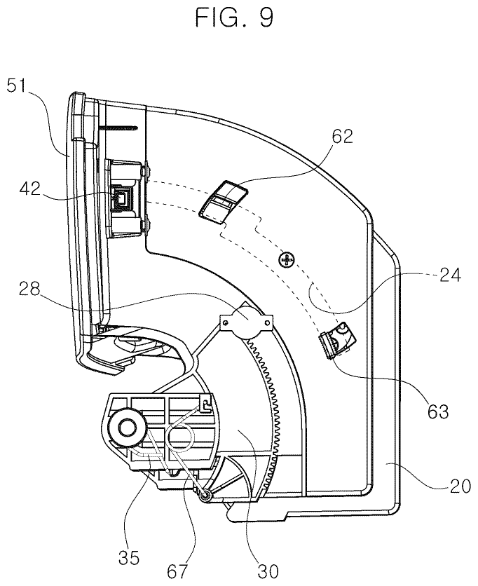

FIGS. 3 and 9 illustrate a state where the inner cover 30 closes the front surface of the housing 20.

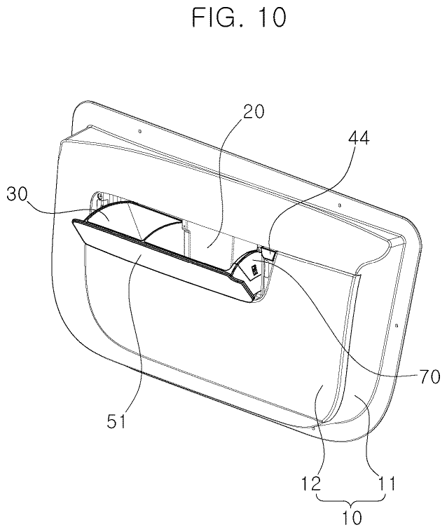

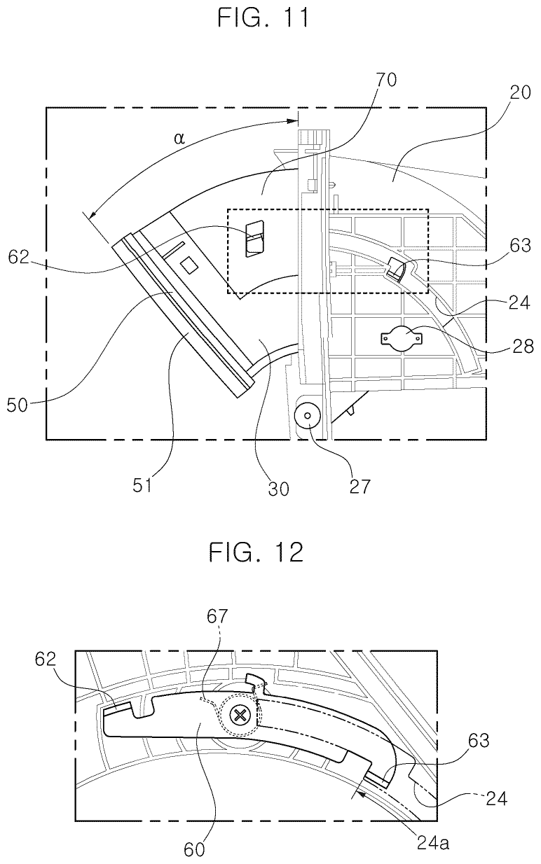

When the occupant operates the button 44 to load and unload an article into and out of the multi-stage open-type vehicular storage compartment according to embodiments of the present disclosure, the inner cover 30 is opened to the first stage with respect to the housing 20 (refer to FIGS. 10 and 11).

When the button 44 is operated, one end portion of the rod 42 is separated from the locking groove 23. Thus, the inner cover 30 is unlocked, thereby rotating by the torsion spring 35 installed on the hinge pin 27 and thus opening the inner cover 30 to the first stage.

At this point, the control lever 60 moves along the first section 24a of the guide slot 24 while rotating along with the inner cover 30. When the stopper 63 reaches the end portion of the first section 24a, the stopper 63 is hooked on the end portion of the first section 24a, thereby restricting the movement of the control lever 60. Thus, the inner cover 30 is in a state of no longer rotating.

Particularly, the stopper 63 on the control lever 60 is elastically supported in such a manner as to face toward the rotational center of the inner cover 30. Thus, the inner cover 30 no longer rotates. Thus, the inner cover 30 maintains a predetermined opening angle α.

The inner cover 30 can accommodate an article into the multi-stage open-type vehicular storage compartment by transitioning from a closed state to a state of being opened to the first stage, when there is no need to load a large-volume article into and out of the multi-stage open-type vehicular storage compartment, or when there is no need to clean the multi-stage open-type vehicular storage compartment.

The inner cover 30 is further opened to the second stage when there is a need to load and unload a large-volume article into and out of the multi-stage open-type vehicular storage compartment or when there is a need to clean the multi-stage open-type vehicular storage compartment.

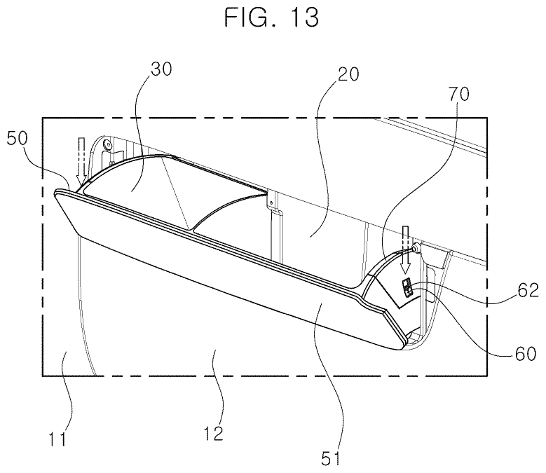

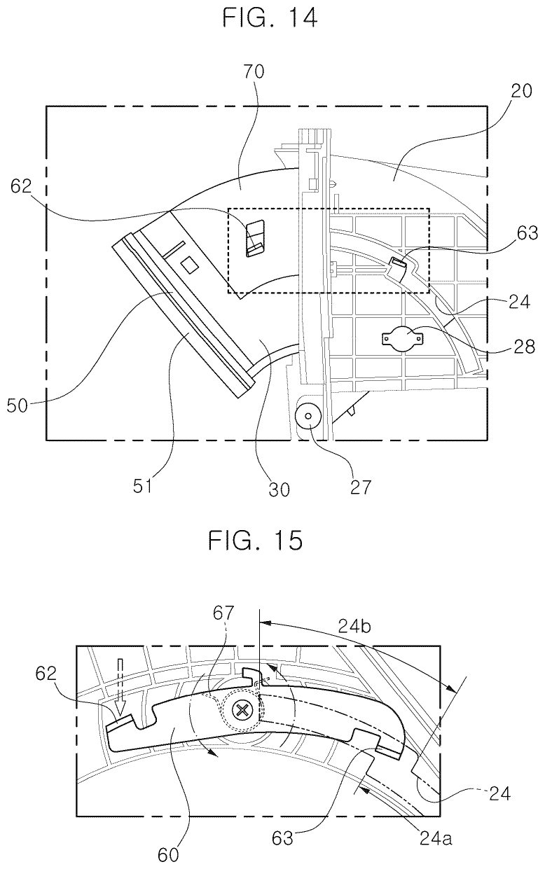

In order to open the inner cover 30 to the second stage, first, the occupant rotates the control lever 60 by pushing the operation portion 62 and thus moves the stopper 63 from an ending point of the first section 24a to a starting point of the second section 24b (refer to FIGS. 13 to 15).

When the occupant pushes the operation portion 62, the control lever 60 rotates about the rotational shaft 32. Thus, the stopper 63 moves from the ending point of the first section 24a to the starting point of the second section 24b, thereby keeping the stopper 63 movable along the second section 24b.

The stopper 63 on the control lever 60 is elastically supported toward the rotational center of the inner cover 30. Because of this, when the control lever 60 does not rotate by pushing the operation portion 62, the stopper 63 stays at an ending point of the first section 24a without moving to the second section 24b. Therefore, when the operation portion 62 is pushed, the stopper 63 moves from the first section 24a to the second section 24b.

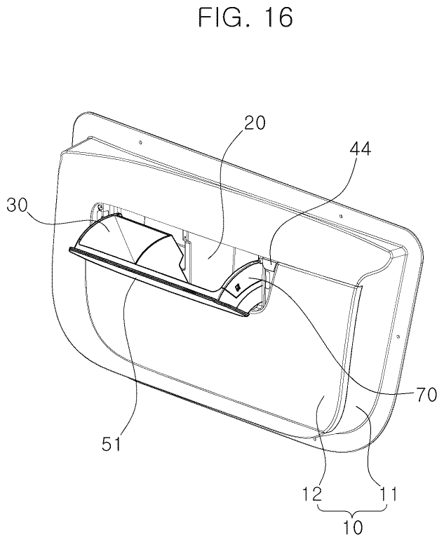

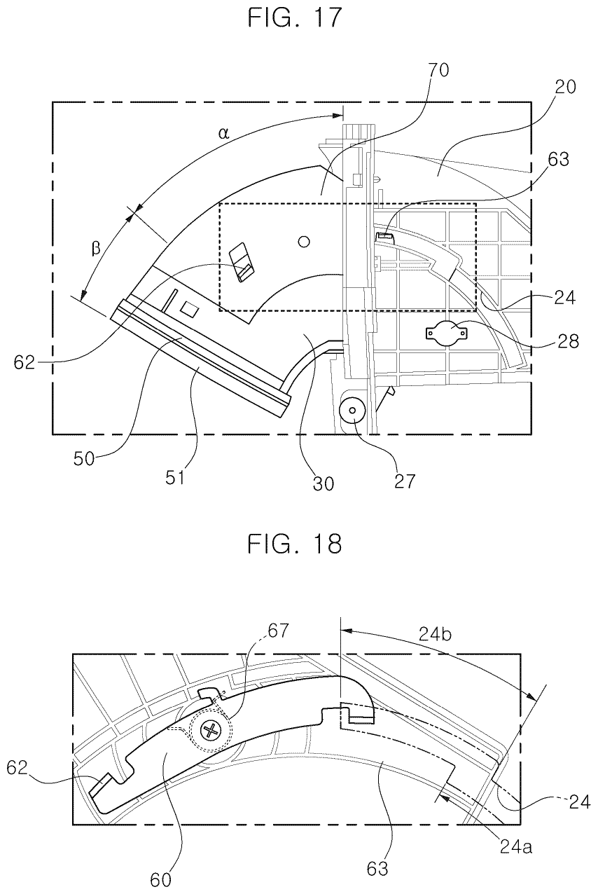

When the stopper 63 finishes moving to the starting point of the second section 24b, the inner cover 30 is opened to the second stage by the torsion spring 35 installed on the hinge pin 27 (refer to FIGS. 16 to 18). Alternatively, the occupant can open the inner cover 30 to the two stages by pulling an upper end portion of the inner cover 30.

When the stopper 63 is positioned in the second section 24b, the stopper 63 can move along the second section 24b, and accordingly, the inner cover 30 can be further opened.

The inner cover 30 can rotate until the stopper 63 is positioned at an ending point of the second section 24b. Thus, the inner cover 30 can be farther opened by an additional opening angle β than when opened to the first stage. That is, the inner cover 30 is opened further by the additional opening angle β when opened to the second stage than when opened to the first stage.

In this manner, when the inner cover 30 is opened to the second stage, a space between an upper end of the inner cover 30 and the housing 20 is further widened. Thus, a large-volume article can be loaded and unloaded into and out of the accommodation units 21 and 22 of the housing 20, or the inside of the multi-stage open-type vehicular storage compartment can be readily cleaned.

In order to close the inner cover 30, when the occupant only pushes an outer surface of the inner cover 30, for example, the skin 51, toward the housing 20, the inner cover 30 closes the front surface of the housing 20. Furthermore, the inner cover 30 is locked on the housing 20.

Regardless of the degree to which the inner cover 30 is opened, the inner cover 30, when pushed in the direction of closing, rotates in the direction in which the housing 20 is closed. While the inner cover 30 is closed, the control lever 60 does not restrict the rotation of the inner cover 30. That is, although the inner cover 30 transitions from a state of being opened to the second stage to the closed state, when the stopper 63 reaches the starting point of the second section 24b, with the torsion spring 67 installed on the rotational shaft 32 and the weight of the control lever 60 itself, the stopper 63 moves to the ending point of the first section 24a without a separate operation. Furthermore, the stopper 63 is in a state of being movable along the first section 24a. Therefore, the inner cover 30 can rotate to the closed state without stopping in a state where the inner cover 30 is opened to the first stage while the inner cover 30 is closed.

When the inner cover 30 reaches a closing position, one end portion of the rod 42, of which a surface is inclined, is readily inserted into the locking groove 23. Thus, the inner cover 30 is in a locked state.

What is claimed is:

1. A multi-stage open-type storage compartment for a vehicle, the storage compartment comprising:
a housing disposed inside the vehicle;
an accommodation space defined within the housing, wherein the accommodation space is configured to accommodate an article;
an inner cover rotatably disposed in the housing, the inner cover being configured to open and close a front surface of the housing;
a guide slot disposed in the housing, the guide slot comprising a plurality of sections arranged as portions, respectively, of circles having different radii and centered around a rotational center of the inner cover, the plurality of sections being connected to each other; and
a control lever rotatably disposed on a lateral surface of the inner cover, wherein the guide slot is configured to guide a movement of the control lever.

2. The storage compartment of claim 1, wherein:
in a state in which the inner cover rotates by a predetermined angle, the control lever reaches a position at an end portion of a first section of the plurality of sections at which rotation of the inner cover is restricted; and
in a state in which the control lever rotates at the position at which the rotation of the inner cover is restricted, the control lever moves to an adjacent second section of the plurality of sections to allow the rotation of the inner cover.

3. The storage compartment of claim 2, wherein the plurality of sections is arranged such that the greater an opening angle of the inner cover, the farther the plurality of sections are positioned away from the rotational center of the inner cover.

4. The storage compartment of claim 3, further comprising a stopper protrusively disposed on a first end portion of the control lever, the stopper being configured to move along an inside of the guide slot, to restrict a rotational angle of the inner cover, and to pass through the guide slot.

5. The storage compartment of claim 4, wherein:
in a state in which the stopper reaches an ending point of a section of the plurality of sections, the stopper is configured to restrict the rotation of the inner cover; and
in a state in which the stopper moves from the ending point of the section to a starting point of an adjacent section of the plurality of sections, the stopper is configured to allow the rotation of the inner cover.

6. The storage compartment of claim 4, further comprising an operation portion protrusively disposed on a second end portion of the control lever, wherein the operation portion is configured to receive an operation force applied to rotate the control lever.

7. The storage compartment of claim 6, further comprising a lever cover disposed on an outer surface of the inner cover and covering the control lever.

8. The storage compartment of claim 7, further comprising:
an operation groove disposed in the lever cover, wherein the operation portion is configured to pass through the operation groove; and
a guide groove disposed in the lever cover, wherein the stopper is configured to pass through the guide groove.

9. The storage compartment of claim 8, wherein the operation groove and the guide groove are configured to restrict a rotational angle of the control lever.

10. The storage compartment of claim 4, wherein the control lever is elastically supported toward the rotational center of the inner cover.

11. The storage compartment of claim 10, further comprising:
a rotational shaft disposed on the inner cover, wherein the control lever is rotatably disposed on the rotational shaft; and
a torsion spring disposed on the rotational shaft and configured to elastically support the stopper toward the rotational center of the inner cover, wherein a first end portion of the torsion spring is fixed to the inner cover and a second end portion of the torsion spring is fixed to a spring fixation portion disposed on the control lever.

12. The storage compartment of claim 1, wherein the housing is fixed to a door trim disposed on a door of the vehicle.

13. A multi-stage open-type storage compartment for a vehicle, the storage compartment comprising:
a housing disposed inside the vehicle;
an accommodation space defined within the housing, wherein the accommodation space is configured to accommodate an article;
an inner cover rotatably disposed in the housing, the inner cover being configured to open and close a front surface of the housing;
a guide slot disposed in the housing, the guide slot comprising a plurality of sections arranged as portions, respectively, of circles having different radii and centered around a rotational center of the inner cover, the plurality of sections being connected to each other;
a cover plate coupled to a front surface of the inner cover;
a rod disposed between the inner cover and the cover plate, wherein the rod is configured to be slidable in a widthwise direction of the inner cover and is insertable into a locking groove disposed in the housing;
a button disposed on the housing, the button being configured to be operated to separate the inner cover from the housing; and
a control lever rotatably disposed on a lateral surface of the inner cover, wherein the guide slot is configured to guide a movement of the control lever.

14. The storage compartment of claim 13, wherein the button comprises:
a pushing portion configured to be pushed by an occupant in the vehicle; and
an operation portion configured to come into inclined contact with the pushing portion to separate the rod from the housing.

15. The storage compartment of claim 14, further comprising:
a second rod disposed between the inner cover and the cover plate, wherein the second rod is configured to be slidable in the widthwise direction of the inner cover and is insertable into the locking groove disposed in the housing;
a guide configured to guide sliding of the rod and the second rod; and
a pinion engaged with rack gear portions disposed on the rod and the second rod, respectively.

16. The storage compartment of claim 13, wherein the housing is fixed to a door trim disposed on a door of the vehicle.

17. A vehicle comprising:
a vehicle body;
a vehicle door coupled to the vehicle body;
a door trim disposed on the vehicle door;
a storage compartment housing fixed to the door trim and facing an interior of the vehicle;
an accommodation space defined within the storage compartment housing, wherein the accommodation space is configured to accommodate an article;
an inner cover rotatably disposed in the storage compartment housing, the inner cover being configured to open and close a front surface of the storage compartment housing;
a guide slot disposed in the storage compartment housing, the guide slot comprising a plurality of sections arranged as portions, respectively, of circles having different radii and centered around a rotational center of the inner cover, the plurality of sections being connected to each other;
a control lever rotatably disposed on a lateral surface of the inner cover, wherein the guide slot is configured to guide a movement of the control lever; and
a stopper protrusively disposed on a first end portion of the control lever, the stopper being configured to move along an inside of the guide slot, to restrict a rotational angle of the inner cover, and to pass through the guide slot.

18. The vehicle of claim 17, wherein:
in a state in which the inner cover rotates by a predetermined angle, the control lever reaches a position at an end portion of a first section of the plurality of sections at which rotation of the inner cover is restricted;
in a state in which the control lever rotates at the position at which the rotation of the inner cover is restricted, the control lever moves to an adjacent second section of the plurality of sections to allow the rotation of the inner cover; and
the plurality of sections is arranged such that the greater an opening angle of the inner cover, the farther the plurality of sections are positioned away from the rotational center of the inner cover.

19. The vehicle of claim 17, wherein:
in a state in which the stopper reaches an ending point of a first section of the plurality of sections, the stopper is configured to restrict the rotation of the inner cover; and
in a state in which the stopper moves from the ending point of the first section to a starting point of an adjacent second section of the plurality of sections, the stopper is configured to allow the rotation of the inner cover.

20. The vehicle of claim 17, further comprising:
an operation portion protrusively disposed on a second end portion of the control lever, wherein the operation portion is configured to receive an operation force applied to rotate the control lever;
a lever cover disposed on an outer surface of the inner cover and covering the control lever;
an operation groove disposed in the lever cover, wherein the operation portion is configured to pass through the operation groove; and
a guide groove disposed in the lever cover, wherein the stopper is configured to pass through the guide groove.
